(19) United States
(12) Patent Application Publication
(10) Pub. No.: US 2026/0187551 A1
(43) Pub. Date: Jul. 2, 2026

(54) RESPONSE WORKFLOW ORCHESTRATION WITH AUTONOMOUS TASK ASSIGNMENT

(71) Applicant: Microsoft Technology Licensing, LLC, Redmond, WA (US)

(72) Inventors: Fady COPTY, San Jose, CA (US); Yoav YASSOUR, Zikhron Yaakov (IL); Roee OZ, Tel Aviv (IL); Tamer SALMAN, Haifa (IL); Tomer TELLER, Tel-Aviv (IL)

(21) Appl. No.: 19/002,008

(22) Filed: Dec. 26, 2024

(51) Int. Cl. G06Q 10/0631; H04L 51/02

(52) U.S. Cl. CPC G06Q 10/063112; H04L 51/02

(57) ABSTRACT

A method disclosed herein facilitates autonomous learning of an ownership data structure and use of the ownership data structure to assign tasks in a response workflow. The method includes determining a sequence of tasks in the response workflow and accessing a security graph to retrieve resource information pertaining to a target resource of a select task in the sequence of tasks. The method further includes using the resource information to generate a roll description that identifies one or more attributes of a candidate qualified to perform the select task and selecting a first individual from the ownership data structure as a candidate for ownership of the select task based on the roll description and descriptions of employment rolls stored within an ownership data structure of the enterprise. The method still further provides for creating a ticket in a ticketing system that assigns the select task to the first individual.

### BACKGROUND

Enterprises commonly implement automated tools to detect security exposures such as data leaks and to monitor public listings of common vulnerabilities and exposures (CVEs) such that alerts can be generated when a new CVE is exposed in software used by the enterprise. When a new security exposure is detected within an enterprise, such as by an automated tool, security administrator, or information technology (IT) department analysis, a security team is typically tasked with selecting an appropriate response strategy. The selection of the response strategy is dictated, at least in part, by the severity of the security exposure. Examples of response strategies include fixing the root cause of the security exposure, compensating with controls (e.g., adding measures that make it more difficult to exploit a vulnerability), placing a claim with a third-party cyber liability insurance company, and implementing additional security monitoring measures.

Following the selection of a response strategy, decisions are made to mobilize the correct and most effective teams to implement the response strategy. It can be complex and time-consuming for a security administrator to identify personnel that are both qualified and authorized to implement the full scope of the response strategy. This may entail breaking down the exposure in sub-tasks that need to be delegated to different teams with different areas of expertise. After selecting a team/department to implement a particular task, an appropriate individual on that team needs to be selected to assume “ownership” of the task, which entails some assessment of the skills and access control levels of different team members—much of which is not documented or known to security personnel. Once an individual is selected as a task owner (e.g., to assume responsibility of a particular task), the security administrator may create a ticket within a ticketing system that connects the owner to the task, allowing progress to be tracked and follow-up actions taken. In many cases, security teams make phone calls, send messages, and “guess” when assigning tasks. This is time consuming and frequently results in the assignment of tasks to the wrong owners—e.g., individuals that lack the appropriate skills and/or access level-resulting in tedious reassessment and assignment of tasks, which disadvantageously reduces the time to implementation of the response strategy.

### SUMMARY

According to one implementation, a method for autonomously assigning tasks in a response workflow includes determining a sequence of tasks in the response workflow and accessing a security graph to retrieve resource information pertaining to a target resource of a select task in the sequence of tasks. The resource information includes relationship data for the target resource that identifies an entity with access to the target resource or resource metadata that identifies a team, project, or employment roll associated with the target resource. The method further includes using the resource information to generate a roll description that identifies one or more attributes of a candidate qualified to perform the select task and selecting a first individual from the ownership data structure as a candidate for ownership of the select task based on the roll description and descriptions of employment rolls stored within an ownership data structure of the enterprise. The method still further provides for creating a ticket in a ticketing system that assigns the select task to the first individual.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates a workflow orchestration system including a task assignment agent that populates and maintains an ownership data structure used to autonomously assign tasks to enterprise employee.

FIG. 2 illustrates aspects of another example workflow orchestration system including a task assignment agent that uses security graph information to learn the ownership data structure of an organization and autonomously assign tasks.

FIG. 3 illustrates aspects of another example workflow orchestration system that uses transcripts of chats with employees to inform autonomous task assignment.

FIG. 4 illustrates aspects of another example workflow orchestration system that uses recorded ownership information pertaining to previously assigned tasks to inform autonomous task assignment.

FIG. 5 illustrates aspects of another example workflow orchestration system that uses a generative language model to identify candidates for assuming ownership of a particular task.

FIG. 6 illustrates example operations for autonomously learning an ownership data structure of an enterprise and using the ownership data structure to assign tasks in a workflow to corresponding owners.

FIG. 7 illustrates an example computing device for use in implementing the described technology.

### DETAILED DESCRIPTION

The herein disclosed technology includes an artificial intelligence (AI) agent that generates detailed workflows to implement event response strategies, autonomously identifies qualified “candidates” for implementing individual tasks within each workload, interacts with candidates as appropriate to collect ownership information, and ultimately delegates the tasks within each response workflow to qualified owners. The AI agent collects ownership information and stores the collected information in a centralized data structure that evolves over time, facilitating quicker selections of owners, assignments of tasks, and a reduction in response times to critical events, such as security exposures.

As used herein, the term “owner” refers to an individual that is selected to assume responsibility for implementing an action on a target resource as part of an event response workflow. The owner of a task is a human that possesses both the skill that is necessary to execute the task and that has the appropriate authorizations (permissions) to access the resource(s) that the task requires access to

According to one implementation, the herein-disclosed AI agent autonomously populates a graph-based ownership data structure with various types of information relevant to task ownership. In existing systems, some of this ownership information is not documented in any fashion, in part because existing systems have not yet been developed to reduce the tremendous burden of collecting and centralizing this information. The disclosed AI-populated ownership data structure merges together roll information for company personnel together with skill attributes and access attributes, some of which are passively discovered based on information extracted from a security graph that maps relationships between resources and entities of an enterprise, such as relationships between devices, accounts, documents, secrets, services, systems, and identities.

As used herein, “roll information” refers to information that describes an individual's position (roll) within an enterprise. One traditional way to store roll information is within an organizational chart that identifies a management hierarchy and various employment titles of different individuals (e.g., manager, development team lead, engineer level III, research analyst level II). Although some organizational charts include job descriptions and profile information that identifies project(s) that particular individuals have been involved with, this information is typically high level and forward-looking (e.g., what an employee is expected to do) rather than backward-looking (e.g., what an employee has actually accomplished in terms of specific actions on specific resources). For instance, an organizational chart would typically not include a record of the specific tasks delegated to the employee throughout their tenure with the organization or identify specific resources that the employee has accessed frequently. Due to these shortcomings, an organizational chart has limited value in informing a decision-maker about the specific capabilities of any particular individual.

Moreover, enterprises often fail to update their organizational charts in a timely manner when re-orgs occur. This further complicates the challenge of assigning tasks in response workflow to qualified owners. Per the herein-disclosed technology, an AI agent populates and autonomously maintains a graph-based ownership data structure that includes nodes corresponding to company personnel. Initially, these nodes are populated with types of roll information that may be available in a traditional organizational chart. However, by analyzing relationships identified in a security graph of the enterprise (e.g., maintained by a security team), the herein-disclosed AI agent draws inferences about the skills and capabilities that are associated with different rolls, with examples of rolls including position titles, access levels, and teams, all of which may be reflected as or associated with identities or metadata within the security graph. By leveraging these inferred associations between rolls and skills in connections with the roll information that is directly associated with names in the company's organizational chart, the AI agent is able to match inferred skills and capabilities to specific individuals. The graph-based ownership structure is, in one implementation, populated over time to identify specific skills possessed by individuals, resources that different individuals have access to, and tasks that individuals have been entrusted with in the past.

The above-described ownership data structure merges traditional roll information (employee titles and high-level job descriptions) with skill attributes and security access information in a way that facilitates accurate and entirely autonomous assignment of tasks to qualified personnel. This represents a significant improvement over prior art technologies designed to aid in high-level workflow management. As mentioned above, these existing technologies are largely limited to tools that expose traditional roll information and contact information that, at most, makes it possible for a workflow orchestrator to manually contact employees and inquire about specific skills and access levels in relation to each specific task that needs to be assigned. This improved data structure directly improves AI inferencing in relation to an organization's inherent ownership structure, which decreases responses time to critical security events that eliminates must of the time-costly burden of matching workflow tasks to qualified owners. This improves the field of security data systems as a whole and amounts to significantly more than comparing and organizing information.

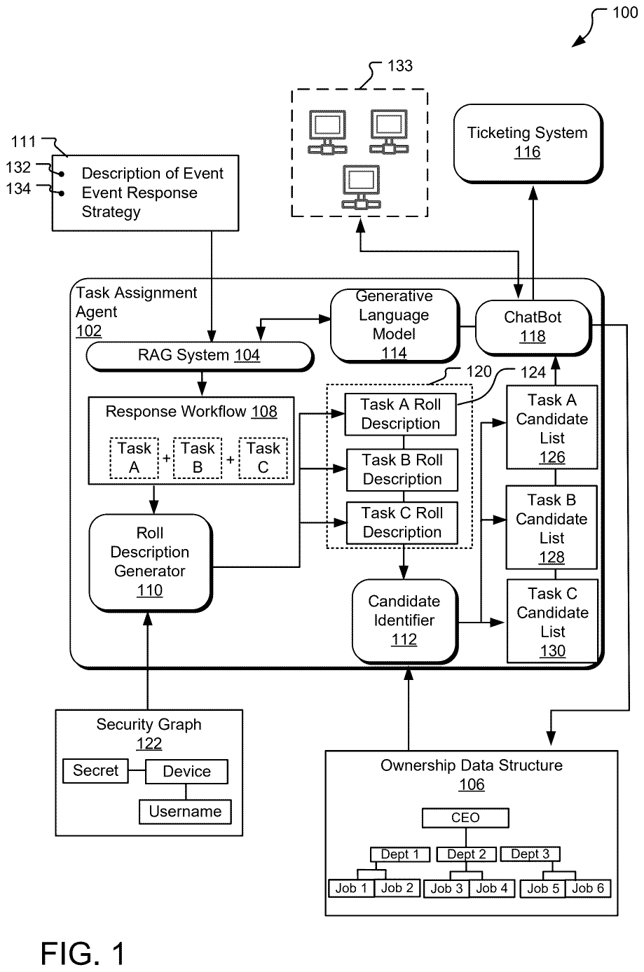

FIG. 1 illustrates a workflow orchestration system 100 including a task assignment agent 102 that populates and maintains an ownership data structure 106 used to autonomously (meaning, without oversight or action by a system administrator) assign tasks to enterprise employees via a ticketing system 116. In the present example, it is assumed that the enterprise implements additional system(s) (not shown) to initially document action items for enterprise employees, where each action item may identify sub-task(s) that need to be assigned to responsible individuals (“owners”). Action items include tasks assigned by various individuals lacking the requisite skills or authorization(s) to complete those tasks. For example, problems may be identified in relation to an enterprise's software systems, devices, or products (e.g., products that are either used by the enterprise or sold by the enterprise) that are, in turn, documented in association with “action items” that need to be implemented to address or mitigate the problems.

These action items are received as inputs to the task assignment agent 102. Specifically, the task assignment agent 102 is shown receiving inputs 111 that include an event description 132 and an event response strategy 134. The event description 132 describes an event that resulted in creation of an action item, and the event response strategy 134 identifies what the action item is. Various examples of “events” and “event response strategies” provided here relate to security exposures and responses that an enterprise elects to take in response to the security exposures. However, the disclosed technology is also contemplated for use in responding to other types of events that trigger action items consisting of sub-task(s) that need to be delegated to appropriate skilled individuals within an enterprise.

In different implementations, the event response strategy 134 may include varying degrees of detail. In one implementation that includes a retrieval augmentation generation (RAG) system 104 (as in the example of FIG. 1, described below), the event response strategy is a high-level, generalized strategy that may not articulate a detailed sequence of tasks. If, for example, the event description indicates that a particular secret (key) was exposed to an unauthorized party, the corresponding event response strategy may indicate that the response is to “update the key”. Alternatively, if the event description indicates that a vulnerability was discovered in a particular operating system driver, the corresponding event response strategy may be to “deploy a patch.”

In other implementations where the task assignment agent 102 lacks the RAG system 104 (described below), the event response strategy may be very detailed and include the specific sequence of tasks illustrated in FIG. 1 and described below with respect to the “response workflow 108.”

In response to receiving the inputs 111, the task assignment agent 102 passes the inputs to the RAG system 104 along with a text-based instruction that requests generation of the response workflow 108. For example, the event description and event strategy may be passed to the RAG system 104 with an instruction may reads “generate a specific sequence of tasks executable to implement the [Response Strategy] for responding to the event described by the [Event Description].” Per this instruction, the RAG system 104 is tasked with generating the response workflow 108, which identifies a specific sequence of tasks that is to be executed to implement the event response strategy.

The RAG system 104 is configured to access an index or, in some cases, multiple different indices populated with reference materials stored in the form of data chunks. Upon receiving the inputs 111 and the above-described instruction to generate the response workflow 108, the RAG system 104 embeds the inputs 111 as a vector represented within a vector space in which vector-to-vector separations are indicative of a degree of semantic similarity between the corresponding embedded text. In addition to storing the above-described index (or multiple indices), the RAG system 104 also stores a separate vector embedding corresponding to each indexed data chunk. The RAG system 104 performs a semantic retrieval operation to identify a subset of the indexed data chunks that satisfy similarity criteria with the inputs 111. These data chunks are selected to serve as “context data” that is then passed to a generative language model 114 along with the original instruction received at the RAG system 104 (e.g., “use this [context data] to generate a specific sequence of tasks executable to implement the [Response Strategy] for responding to the event described by the [Event Description]”).

In the example of FIG. 1, it is assumed that the inputs 111 include sufficient information to enable the RAG system 104 to identify the resources involved in implementing the response strategy as well as the systems, applications, or parties that may be impacted by updates to each of the resources. The generative language model 114 is a model trained to interpret textual inputs, and may for example be a natural language processing (NLP) model or a multimodal models that can receive prompts that include various types of input (e.g., text, image, audio, and/or video data) and likewise generate outputs of multiple types that are not necessarily the same as the input type. Further examples of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

In response to receiving the above-described instruction from the RAG system 104, the generative language model 114 generates and returns the response workflow 108, which includes a detailed sequence of tasks. Each task in the response workflow 108 identifies at least one target resource and an action that is to be performed on the target resource. Examples of target resources include applications (e.g., source code that is to be modified), systems (e.g., system configuration changes), devices (e.g., devices hardware or software configuration changes), database tables, files, and secrets. If, for example, the inputs 111 indicate that a security vulnerability was discovered within a particular application used by various devices across the enterprise and the response strategy is to “roll out a patch,” the response workflow 108 may include a first task that provides for developing a patch that addresses the vulnerability and a second task that provides for downloading and installing the patch on all machines within the enterprise that execute the application. In this example, the first task is a development task that typically be performed by a software developer, while the second task is an operations task (installing updates on company machines) that would typically be performed by an IT admin.

By example, the response workflow 108 is shown to include three tasks—Task A, Task B, and Task C. One by one, each task in the response workflow 108 is provided to a roll description generator 110. By applying techniques described further below, the roll description generator 110 generates, for each of the tasks (A-C), a description of an employment roll served by a candidate that is qualified (e.g., possesses the requisite skills and the appropriate access levels) to be named “owner” of the task. The description of the employment roll corresponding to each task is also referred to herein as a “Roll Description” and FIG. 1 identifies a trio of roll descriptions 120, each of which corresponds to one of the tasks in the response workflow 108 (e.g., Task A Roll Description 124 corresponds to “Task A” in the response workflow 108).

The roll descriptions 120 are generated based, at least in part, upon analysis of data extracted from a security graph 122. In one implementation, the security graph 122 is a graph-based database used to inform exposure management decision making, such as to make it possible to understand the likely implications of a security exposure in view of how the exposed resource is related to other resources and identities. The security graph 122 includes nodes that correspond to identities and resources of the company. In this context, an identity represents an entity that can interact with resources or perform actions on resources. Examples of identities include devices (e.g., MAC addresses), applications (e.g., application identifiers), services (e.g., application programming interface (API) clients), and users (e.g., usernames, email addresses). In contrast, the term “resource” refers to an object, service, or data that can be accessed, modified, or interacted with by an identity. Examples of resources include files, databases, secrets (keys), cloud services (e.g., API endpoints), and storage accounts. In the security graph 122, relationships between nodes (identities and resources) are shown as edges. For example, the security graph 122 may include a first node identifying a secret connected via an edge to a second node representing a device that stores the secret. The second node representing the device may be further connected to a third node representing a storage account that is also stored on the device, and the third node is further connected to a collection of nodes corresponding to individuals (e.g., usernames) that have access to the storage account.

In addition to the above, the nodes in the security graph 122 store metadata that provides further information about the corresponding resource or identify. For example, a resource node in the security graph 122 identifies a specific resource by name and stores resource metadata that indicates information such as where the resource is specifically located (e.g., device, file path). The resource metadata additionally identifies systems, applications, and services known to utilize the resource and includes tags that identify other names for the resource, project(s) the resource is associated with, teams that have access to the resource, a security clearance level needed to access the resource (e.g., Top Secret, Secret, Confidential, Non-classified), or a specific rolls (employment titles) with access to the resource (e.g., R&D Dept Admin-only).

When generating the roll description corresponding to a particular task (e.g., the Task A Roll Description 124), the roll description generator 110 queries the security graph 122 to retrieve information pertaining to the target resource of the task. This retrieved information may, for example, include relationship data for the target resource that identifies one or more identities (other nodes in the security graph 122) that have access to the target resource as well as resource metadata for the target resource that, for example, describes the contents of the target resource, identifies teams or systems that the resource is designed to benefit or serve, identifies where the resource resides, or that identifies tags known to be associated with the resource such as project names, team names, or rolls (job titles) associated with the target resource and the relative nature of those associations.

Using the information retrieved from the security graph 122 pertaining to the target resource of a task in the response workflow 108 (e.g., Task A), the roll description generator 110 infers one or more access attributes or skill attributes potentially relevant to completion of the task (e.g., Task A). As used herein, an “access attribute” is an attribute descriptive of a type data access an individual has, whereas the term “skill attribute” is an attribute descriptive of a behavioral pattern of a user or a particular action that an individual has performed, either of which is potentially indicative of the capability of individual to perform an action on a target resource. Both skill attributes and access attributes represent desired characteristics of the ultimate “owner” of the task that is to be assigned.

The skill attributes and roll attributes identified by the roll description generator 110 are added to a roll description corresponding to the task (e.g., the Task A Roll Description 124). If, for example, the metadata for the target resource of Task A indicates that the resource is classified as Top Secret, the Task A Roll Description 124 may include an access attribute that reads “Candidate has ‘Top Secret’ Security Clearance.” Alternatively, if the metadata for the target resource of Task A indicates that the target resource is stored in a particular repository, the Task A Roll Description 124 may include a skill attribute that reads “Candidate is frequent accessor of [Repository Name].”

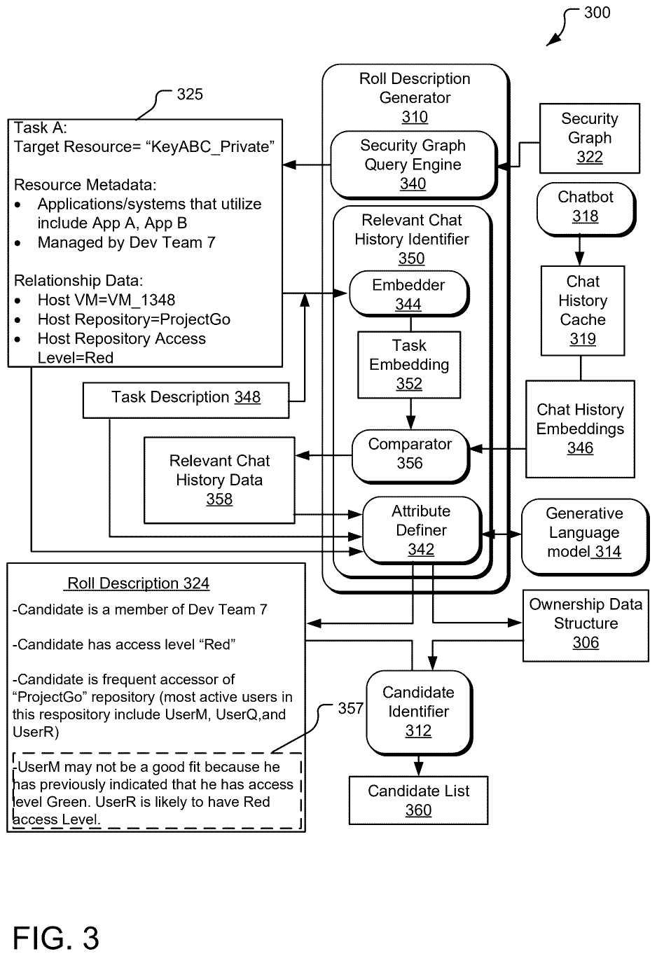

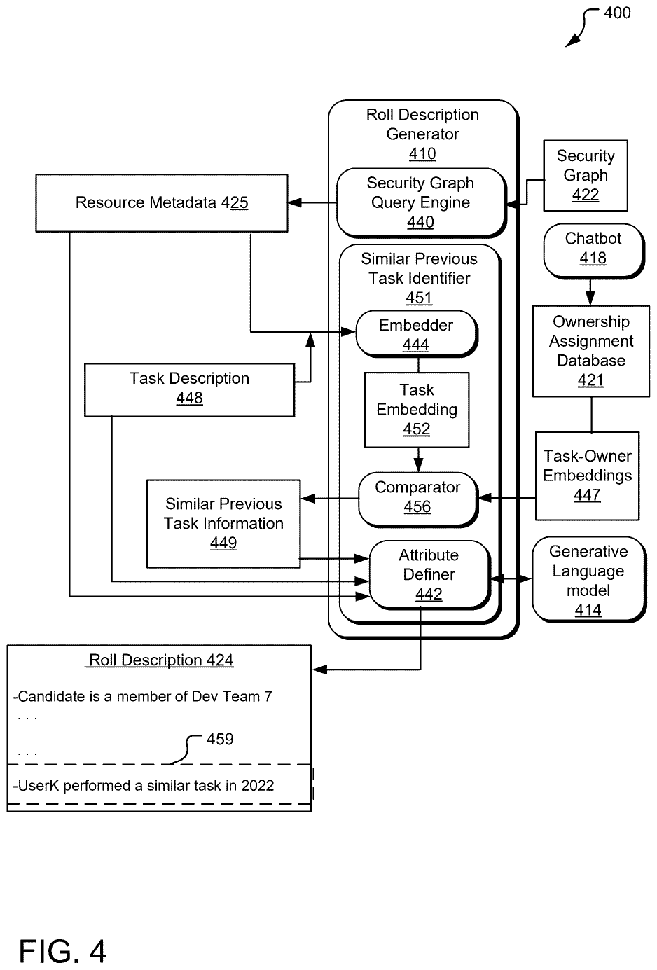

In some implementations, the roll descriptions may incorporate additional types of information—namely, skill attributes and access attributes that can be inferred from previous tasks that the task assignment agent 102 has investigated (e.g., per the above-described operations) and ultimately assigned. For example, the Task A Roll Description 124 may identify information pertaining to previous tasks identified as being “similar to” Task A, as well as the owners that those previous tasks were assigned to or attributes of those owners (e.g., rolls served by those individuals within a company, access levels of the individuals, skills possessed by the individuals). Likewise, the Task A Roll Description 124 may, in some implementations, incorporate chat histories that include transcripts of conversations between a chatbot 118 of the task assignment agent 102 and candidates that were interviewed (as is further discussed below) during the course of selecting an owner for a previous task. These additional types of information (similar previous task information and chat histories) are not required for implementation and are discussed in greater detail with respect to FIG. 3 and FIG. 4.

Once the roll description has been generated for a particular task per the general operations described above, a candidate identifier 112 receives the roll description (e.g., the Task A Roll Description) and identifies candidates potentially qualified for the roll of task owner. This identification of candidates depends at least in part upon cross-inferencing between the roll description and roll information that is, at the time of task delegation, stored in an ownership data structure 106. In one implementation, the ownership data structure 106 is initialized as an organizational chart that identifies the names of employees of an organization, the rolls (e.g., titles) of the employees, and that further identifies a managerial hierarchy (e.g., who each employee reports). In some implementations, the ownership data structure 106 also identifies a general division of departments or teams within the organization and assignment of the employees to those teams or departments.

To be able to meaningfully select candidate(s) for an ownership task, it is assumed that the ownership data structure 106 is populated with at least some form of organizational chart that identifies employees and rolls (titles). However, it is contemplated that in some implementations, the ownership data structure 106 is initially blank or very skeletal, such as including employee names and no other information. In these implementations, the chatbot 118 of the task assignment agent 102 autonomously conducts interviews (e.g., via webchat) with different individuals to ask questions relevant to employment rolls and to thereby acquire information about the employment roll that is served by everyone that is interviewed. Over time, the ownership data structure 106 is populated with the collected data to resemble some type of org chart as is generally described above. At this point in time, the ownership data structure 106 can be used as a basis for assigning tasks in the response workflow 108 to specific individuals.

In each roll description that is nominally generated per the above-described operations, it is likely for there to exist some form of overlap between information between the skill and access attributes identified in the roll description and the roll information that is included in the ownership data structure 106. For example, the Task A Roll Description 124 may indicate that the ideal candidate is a member of a particular development team (e.g., identified by a metadata tag for the target resources within the security graph), in which case the candidate identifier 112 accesses the ownership data structure 106 and identifies members of the particular development team to assemble an initial list of candidates for the ownership task. By further example, the Task A Roll Description 124 may additionally indicate that the ideal candidate has admin level access within a particular repository. Depending upon the granularity of data stored within ownership data structure 106, this information may be useful in further narrowing the group of candidates to exclude some members of the particular development team. For example, even if the ownership data structure 106 does not identify specific access levels or identify repositories associated with those access levels, it may be inferred (e.g., by prompting a language model, by apply heuristic rules, or otherwise), that lower levels of employees of the development team are less likely to have admin access than higher-level employees. This type of inferencing allows the candidate identifier 112 to rank the candidates in terms of likely fit for the role and/or narrow the pool of candidates.

In one implementation, the candidate identifier 112 provides the generative language model 114 with inputs that include the description of the employment roll, a text-based representation of information in the ownership data structure 106, and an instruction to select one or more candidates from the ownership data structure 106 based on the description of the employment roll. In response, the generative language model 114 generates the candidate list. In another implementation, the candidate identifier 112 applies hard-coded inferencing rules to produce the candidate list for a particular task.

In FIG. 1, the candidate identifier 112 is shown generating a list of candidates for each of the three tasks in the response workflow 108—e.g., Task A Candidate List 126, Task B Candidate List 128, and Task C Candidate List 130. These candidate lists are initially generated per operations described above. In implementations where there is sufficient information available to rank candidates for ownership of Task A in terms of probability of having the skills and access permissions needed to implement the task, the Task A Candidate List 126 includes a ranked list of names.

Once a candidate list is initially generated as described above, the chatbot 118 commences an investigation to inquire about ownership of the task, collect additional information that may be used to modify or narrow the candidate list, and update the information stored within the ownership data structure 106. This investigation entails initiating a chat-based “interview” with one or more different candidates via their respective user devices 133. For example, upon receiving the Task A Candidate List 126, the chatbot 118 initiates a web-based chat with a select candidate—typically, the candidate that is highest-ranked if ranking is available or else a randomly-selected candidate. The chatbot 118 is, in one implementation, a web-based application that controls a user interface displayed on a user device and communicates inputs received from a user through the user interface to the generative language model 114, which is, on the backend, instructed to generate responses and follow-up questions that the chatbot 118 conveys back to the user.

During this agent-initiated chatbot session with a candidate for Task A, the chatbot 118 initially asks one or more questions to determine whether the candidate is the rightful owner of the task (e.g., possess the appropriate skills and access levels). For example, the chatbot 118 provides the candidate with a description of the event that is included in the inputs 111, an overview of the response strategy, and describes the specific task that the candidate has been identified as potentially capable of implementing. After conveying this information, the chatbot 118 asks the candidate to confirm whether they are able and willing to assume ownership of the task. In response, the candidate provides the chatbot with an ownership confirmation or an ownership denial.

In the event that the candidate accepts ownership, the task assignment agent 102 opens a ticket in a ticketing system 116 that formally assigns Task A to the candidate. Per this action, the candidate becomes the “owner” of the task. Additionally, the task assignment agent 102 updates the node within the ownership data structure 106 corresponding to the candidate (now owner) of the task, such that the updated node identifies the candidate as possessing some or all of access attributes in the Roll Description that was generated for the task ultimately assigned to the candidate. This update to the ownership data structure 106 makes it possible to use skill attributes and access attributes discovered during the assignment of one task to inform future task assignments conducted by the task assignment agent 102, such as by facilitating a much quicker matching between skill attributes and access attributes in a generated roll description with a particular employee of the organization—potentially eliminating the need to interview multiple candidates, as is contemplated below.

In the event that the candidate responds to the inquiry of the chatbot 118 with an ownership denial (e.g., denying ownership of the task in question, e.g., Task A), the chatbot 118 asks follow-up questions that aim to match the particular skill attributes and access attributes in the roll description with particular roll titles or individuals. If, for example, the candidate indicates they are not the rightful owner because they lack the appropriate permission level to access the target resource, the chatbot 118 may respond by asking the candidate if they know which position(s) in the enterprise or particular individuals have the appropriate permission level. If the candidate is able to provide additional information, the chatbot 118 may use the newly acquired information to narrow or modify the candidate list (e.g., the Task A Candidate List 126). If, for example, the candidate responds with “the access level of the resource is only possessed by Team Leads and Team Assistant Leads,” the chatbot 118 determines, from ownership data structure 106, which of the remaining candidates is a Team Lead or Team Assistant Lead and either narrows the candidate list to exclude all others or re-ranks the candidate list to ensure that Team Leads and Team Assistant Leads are at the top of the candidate list (meaning, these individuals will be interviewed next). As information is learned, the chatbot 118 also updates the nodes of the ownership data structure 106. For instance, in the above example, the chatbot 118 would update the nodes that correspond to the Team Leads and Team Assistant Leads on the candidate list to further indicate the access level that is now known to be granted to these individuals.

Likewise, if the candidate indicates they are not the rightful owner because they lack experience in the type of task being assigned, the chatbot 118 may respond by asking the candidate if they know of anyone that is likely to have the experience that is being sought. When the candidate responds with the name(s) of specific individuals, the chatbot 118 may add those individuals to the candidate list or, if one or more of the named individuals is already on the candidate list, the chatbot 118 may re-order the candidates on this so as to rank such individual(s) more highly-meaning, they are to be interviewed sooner.

In this general manner, the chatbot 118 autonomously collects information, updates the ownership data structure 106 as information is learned (e.g., when the candidate clarifies that a particular access attribute or skill attribute on the roll description is possessed by specific individual(s) identified in the ownership data structure 106 or by position titles that are identified on the ownership data structure 106). Over time, the task assignment agent 102 continues to update the ownership data structure 106 such that the nodes identifying specific people further identify the skill attributes and access attributes that are learned, per the above-described inferencing and data collection operations, to be associated with those specific people.

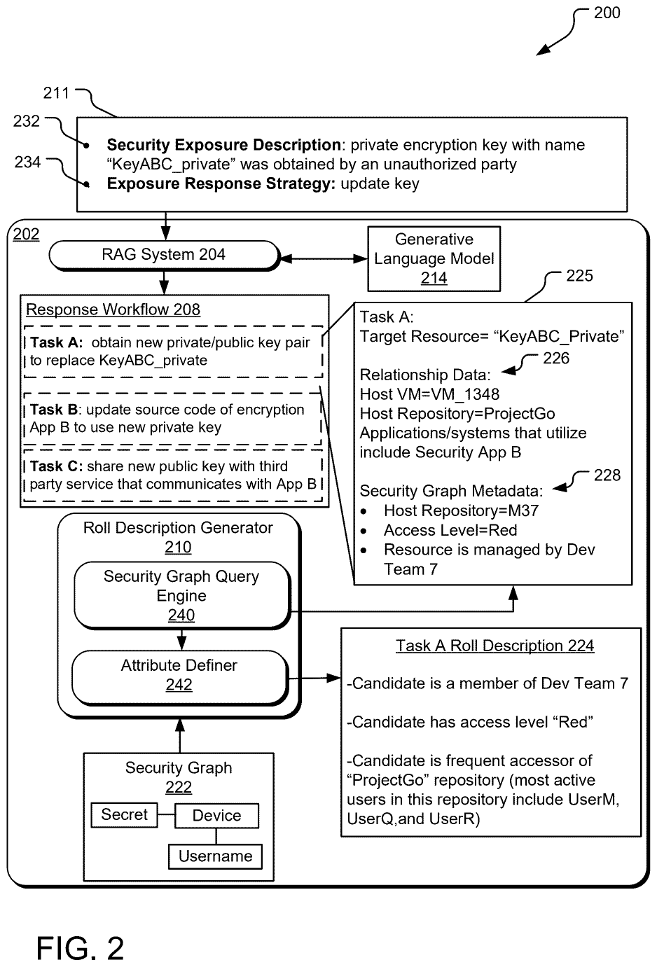

FIG. 2 illustrates aspects of another example workflow orchestration system 200 including a task assignment agent 202 that uses security graph information to learn the ownership data structure (not shown) of an organization and autonomously assign tasks to qualified “owners,” as generally described with respect to FIG. 1. In the example of FIG. 2, the task assignment agent 202 is shown receiving a set of inputs 211 that include a security exposure description 232 (an example “event”) and an exposure response strategy 234 (a generalized strategy for responding to the event). In this example, the security exposure description 232 reads “private encryption key with name KeyABC_private was obtained by an unauthorized party.” The corresponding exposure response strategy 234 reads “update key.”

In response to receiving the inputs 211, the task assignment agent 202 passes the inputs to the RAG system 204 along with a text-based instruction that requests generation of the response workflow 208. For example, the security exposure description 232 and the exposure response strategy 234 is passed to the RAG system 204 with an instruction may reads “generate a specific sequence of tasks executable to implement the [Exposure Response Strategy] for responding to the event described by the [Security Exposure Description].” Per this instruction, the RAG system 204 is tasked with generating the response workflow 208, which identifies a specific sequence of tasks that is to be executed to implement the exposure response strategy. As described with respect to FIG. 1, the RAG system 204 accesses an index storing reference material in the form of data chunks and performs a semantic retrieval operation to identify a fixed number of data chunks (“relevant data chunks”) that have the greatest semantic similarity to the inputs 211. The relevant data chunks serve as context data that is then passed to a generative language model 214 along with the original instruction received at the RAG system 204 (e.g., the request to generate the response workflow 208 based on the inputs 211). In addition to the context data and the original instruction, the generative language model 214 is directed, by the RAG system 204, to respond to the original instruction based upon the context data. The generative language model 214 outputs the response workflow 208.

In this example, the reference material includes company-internal document that indicates information such as what the key is used for, where it is stored, and how it is updated. Using this reference materials, the generative language model 214 creates the response workflow 208, which sets forth a first task (Task A) that provides for obtaining a new asymmetric (public/private) key pair to replace the key pair with keys titles “KeyABC_Private” and “KeyABC_Public”; a second task (Task B) that provides for updating source code of an enterprise-owned application (App B) that utilizes the private key to encrypt outgoing data, and a third task (Task C) that provides for transmitting the public key of the newly-created asymmetric key pair to a third party that utilizes the public/private key pair to decrypt data received from the App B. In this example, the first task entails access to a security system that generates keys, the second task entails communicating sensitive information to a third-party, and the third task entails updating source code of an internally-owned application, such to as update a variable that stores a memory location of the private key that is to be used to encrypt data generated by the application. Notably, there may not exist a singular employee of the enterprise that has the skills an access levels needed to implement all three of these tasks.

Each task of the response workflow 208 is input to a roll description generator 210 that generates, for each of the tasks (A-C), a roll description (e.g., Task A Roll Description 224) that includes information that describes qualifications of the “owner” that is being sought to assume responsibility of the corresponding task. To generate the Task A Roll Description 224, the roll description generator 210 first identifies the target resource of the task and provides this information to a security graph query engine 240. In this example, the target resource of Task A is an asymmetric key pair (KeyABC_public and KeyABC_private). The security graph query engine 240 queries a database management system (not shown) storing a security graph 222 to retrieve resource data 225 that is related to the target resource.

In FIG. 2, it is assumed that the security graph 222 has the same or similar characteristics as the security graph described with respect to FIG. 1. The resource data 225, retrieved from the security graph 222 includes both relationship data 228 and security graph metadata 226. The relationship data 228 identifies relationships that have been documented between the target resource and other resources and identities. In this example, the relationship data 228 identifies the host VM that the target resource resides on, a repository that the target resource is stored in, and an application that is known to access and utilize the target resource (App B). The security graph metadata 226 includes metadata pertaining to both the target resource as well as metadata pertaining to the resources and identities (e.g., other graph nodes) that have relationships with (edges connected to) the node corresponding to the target resource. In the example shown, the security graph metadata 226 identifies an access level that is associated with the host repository storing the target resource and further identifies a particular development team (e.g., Devel. Team #7) that manages the target resource.

The roll description generator 210 further includes an attribute definer 242 that translates the resource data 225 into the Task A Roll Description 224. In one implementation, the attribute definer 242 provides some or all of the resource data 225 as input to the generative language model 214 along with a prompt that instructs the generative language model 214 to use the resource data 225 and a description of Task A (describing an action on the target resource) to craft a description of a candidate that is capable of performing Task A. For example, the generative language model receives an instruction that reads “[H]ere is a list of attributes that describe a target resource and relationships of the target resource. Here is a description of an action that is to be performed on Task A. Use this list of resource attributes and the description of the action to generate a list of attributes or skills that a person would need to have in order to be qualified to perform the action on the target resource.” In response to this prompt, the generative language model 214 outputs the Task A roll Description 224.

In the example shown, the Task A Roll Description 224 identifies two access attributes indicative of access credentials, which reads: “Candidate is a member of development team 7” and “Candidate has access level ‘Red’. In addition, the Task A Roll description 224 further identifies a skill attribute indicative of candidate skill, which reads “Candidate is a frequent accessor of the ‘ProjectGo’ repository.”

In the implementation shown, it is assumed that the attribute definer 242 also has access to repository logfiles and adds additional information to the Task A Roll Description 224 after it is generated by the generative language model 214. Specifically, in response to receiving the model output identifying the fact that the “Candidate is a frequent accessor of the ‘ProjectGo’ repository,” the attribute definer 242 accesses the system log files and tabulates accesses to various resources in the ‘ProjectGo’ repository across different users. The attribute definer 242 identifies three users—User M, UserQ, and User R as being frequent accessors of the repository, and updates the Task A Roll Description 224 to include this information, which is subsequently used to select candidate(s) and assign ownership of Task A.

FIG. 3 illustrates aspects of another example workflow orchestration system 300 that uses transcripts of chats of chats with employees to inform autonomous task assignment. The illustrated aspects of the workflow orchestration system 300 are assumed to be part of an AI agent that provides the same functionality as that described with respect to the implementations of FIG. 1-2. However, in the workflow orchestration system 300, a roll description 324 is generated based on a combination of resource data 325 (e.g., as generally described with respect to FIG. 1-2) and also generated, in part, based on chat history data that collected by a chatbot 318 and stored in a chat history cache 319.

In FIG. 3, the chatbot 318 provides the same functionality described above with respect to FIG. 1. When the task assignments agent 302 identifies a list of candidate(s) (employees at an enterprise) as potential owners for a given task in a workflow, the chatbot 318 initiates a chat with one or more candidates on the list to inquire about ownership of the task, Within each such chat, the chatbot 318 informs the candidate about the nature of the event that is being responded to as well as the event response strategy. The chatbot 318 asks the candidate questions about their skill attributes and access levels and may also ask the same types of questions about other employees of the enterprise (e.g., “do you know who in your department has the skill set to perform this type of task” or “do you know who in your department has the access level that is required to access this resource”). The transcript of each of these conversations is stored in the chat history cache 319. Each transcript is also vectorized by an embedder 344 to create a corresponding chat history embedding defined within a vector space in which each vector-to-vector separation correlates with a degree of semantic similarity of the information embedded by the corresponding vectors. The chat history embeddings stored in an index, shown as chat history embeddings 346.

When the roll description generator 310 receives a task description 348 for a task that is part of a response workflow (e.g., the response workflow 108 in FIG. 1 or the response workflow 208 of FIG. 2), a security graph query engine 340 accesses a security graph 322 to retrieve the resource data 325 for the target resource of the task, as generally described with respect to FIG. 1 or FIG. 2. The resource data 325 is then provided as an input to a relevant chat history identifier 350. In addition to receiving the resource data 325 for the target resource of the Task (e.g., Task A), the relevant chat history identifier 350 is also provided with a task description 348 that describes the task being assigned (e.g., the action that is to be performed on the target resource), and the relevant chat history identifier 350 passes these inputs to the embedder 344, which vectorizes the resource data 325 and the task description 348 to generate a task embedding 352 defined in the same vector space as the chat history embeddings. A comparator 356 then computes a similarity metric, such as a dot product or cosign similarity, between the task embedding 352 and each one of the chat history embeddings 346 to identify one or more of “relevant chat transcripts” in the chat history cache 319 with corresponding chat history embeddings 346 that satisfy a similarity threshold with the task embedding 352 (e.g., a dot product in excess of a threshold). The relevant chat transcripts are shown in FIG. 3 as relevant chat history data 358.

The task description 348, the resource data 325 and the relevant chat history data 358 are, together, provide as inputs to an attribute definer 342 that, in turn, generates a roll description 324 that describes qualifications of a prospective task owner.

In one implementation, the attribute definer 342 provides a generative language model 314 with inputs that include the resource data 325, the task description 348, the relevant chat history data 358, and an instruction to use the resource data 325 and to generate a roll description that describes characteristics of a candidate capable of performing the task described in the task description 348. The generative language model is, in this implementation, also provided with an instruction to use the relevant chat history data 358 to identify specific people within the enterprise that should be considered as candidates for the roll or eliminated from candidacy for the roll.

In one implementation, the above is achieved via a two-part instruction. During a first prompt operation, the generative language model 314 receives the task description 348, the resource data 325, and an instruction such as “[H]ere is a list of resource attributes that describe a target resource. Here is a description of an action that is to be performed on the target resource. Use this list resource attributes and the description of the action to generate a listing of attributes likely possessed by a person qualified to perform the action on the target resource.” After the generative language model generates an output that includes a description of the roll (e.g., the roll description 224 described with respect to FIG. 2), the generative language model 314 is then provided with a second set of inputs that include the roll description generated in the previous query, the relevant chat history data 358, and an instruction such as “This [Roll Description 324] describes a candidate that is being sought to perform a task at an enterprise. This [Relevant Chat History Data 358] includes transcripts that capture conversation with employees at the enterprise. These transcripts may include information that is relevant in selecting candidates for this task. Use the transcripts to try to identify employees likely to be well suited for the roll and candidates that are unlikely to be well suited for the role. In your answer, be sure to explain why each identified person is or is not likely to be well suited for the roll.”

Notably, the relevant chat history data 358 may include discussions pertaining to tasks that describe previous actions similar to the action described in the task description 348 and/or that describe previous actions that operated on resources similar to the target resource of the task being presently assigned (task A). Likewise, the relevant chat history data 358 may include dialog pertaining to the relevant skills and/or relevant access levels of various enterprise employees. In the example of FIG. 3, the roll description 324 initially generated by the generative language model 314 indicates that the ideal candidate may have “access level ‘Red.’” When the generative language model 314 is instructed to use the roll description 324 to identify relevant chat history data 358, the generative language model 314 discovers a previous dialog conducted with UserM in which UserM states that their access level is ‘Green’ and that UserR has access level ‘Red.’” Since this information speaks to who may or may not have an access level attribute in the roll description 324, the identified generative language model 314 identifies this dialog as relevant to Task A, and generates an output that reads “UserM may not be a good fit for the roll because he has previously indicated that he has Green access level. Past conversations indicate that UserR is likely to have Red access level.”

Following the above-described exchange(s) with the generative language model 314, the attribute definer 342 outputs a roll description 324 that identifies attributes of prospective owner of the task being assigned (e.g., as generally described with respect to FIG. 2) as well as additional qualification inferences 357 derived from the relevant chat history data 358. These additional qualification inferences 357 identify relevant qualifications (or lack thereof) of specific individuals.

In one implementation, the attribute definer 342 updates an ownership data structure 306 to include skill attributes and access attributes identified in the additional qualification inferences 357 such that the ownership data structure 306 associates the skill attributes and access attributes with specific individuals, consistent with the additional qualification inferences 357. In the example of FIG. 3, the ownership data structure 306 is updated to indicate that UserM has access level Green and UserR has access Red. Per this update, the ownership data structure 306 can, by itself, be used to confirm the access levels of UserR and UserM, which may be helpful in identifying owners for future tasks.

The ownership data structure 306 is a data structure that may include different types of information depending upon the implementation and at different points in time. In FIG. 3, it is assumed that the ownership data structure 306 identifies employees at the organization and their respective rolls, such as by department and title. Both the ownership data structure 306 and the roll description 324 are provided as inputs to a candidate identifier 312 that generates a candidate list 360 identifying candidates from the ownership data structure 306 that may be potentially qualified for the roll described in the roll description 324. The logic applied to generate the candidate list 360 may be the same or similar to that described with respect to FIG. 1.

In the example of FIG. 3, the resource data 325 and roll description 324 (generated based on the resource data 325) identifies the candidate as being a member of Development Team 7. The ownership data structure 306 identifies all members of Development team 7. The candidate identifier 312 therefore compiles an initial version of a candidate list 360 that includes the members of Development Team 7. In this example, the roll description 324 further identifies the fact that UserM, UserQ, and UserR are frequent accessors of the repository storing the target resource (determined from logfile analysis conducted based following initial identification of the repository in the resource data 325). By cross-referencing the initial version of the candidate list 360, the candidate identifier 312 confirms that UserM, UserQ, and UserR are all members of development Team 7 and modifies the candidate list 360 to rank these three users higher than the remainder of Development Team 7. The candidate identifier 312 then eliminates UserM from the candidate list 360 due to the inferences 357 (determined based on the relevant chat history data 358), which indicate that UserM does not have the access level that is required for Task A. Since the additional qualification inferences 357 also indicate the UserR is “likely” to have the requisite access level, the candidate identifier 312 updates the candidate list 360 to rank UserR higher than UserQ. Consequently, UserR becomes the first-in-line candidate, UserQ becomes the second-in-line candidate, and other members of development team (excluding UserM) are tied as third-in-line candidates.

The candidate list 360 is passed to the chatbot 318, and the chatbot 318 conducts interviews with the top candidates to confirm ownership and assign the task, as generally described with respect to FIG. 1.

FIG. 4 illustrates aspects of another example workflow orchestration system 400 that uses recorded ownership information pertaining to previously assigned tasks to inform autonomous task assignment. The illustrated aspects of the workflow orchestration system 400 are assumed to be part of a AI agent that provides the same functionality as that described with respect to the implementations of FIG. 1-2. However, the roll description generator 410 in FIG. 4 additionally includes a similar previous task identifier 451 that utilizes information in an ownership assignment database 421 to inform generation of a roll description 424 used to select candidates to serve as “owner” of a select task.

In FIG. 4, the chatbot 418 provides some of the same functionality described above with respect to FIG. 1, which includes interviewing potential owners and receiving “ownership confirmations” or “ownership denials” from various candidates pertaining to various tasks being assigned. Each time the chatbot 418 receives an ownership confirmation, the chatbot 418 generates a record of the task assignment in an ownership assignment database 421. Each record in the ownership assignment database 421 includes a task descriptor that describes the task assigned and—e.g., as an action performed on a target resource—and further identifies the owner that the task was ultimately assigned to. An embedder 344 vectorizes each ownership record in the ownership assignment database 421 to create a corresponding task-owner embedding defined within a vector space in which each vector-to-vector separation correlates with a degree of semantic similarity of the information embedded by the corresponding vectors. The task-owner embeddings corresponding to the ownership records are stored in an index, shown as task-owner embeddings 447.

When the roll description generator 410 receives a task description 448 for a task that is part of a response workflow (e.g., as described with respect to any of FIG. 1-3), a security graph query engine 440 accesses a security graph 422 to retrieve resource data 425 for the target resource of the task (again, as described with respect to any of FIG. 1-3). The resource data 425 is then provided as an input to the similar previous task identifier 451, along with the task description 448. The similar previous task identifier 451 passes these inputs to the embedder 444, which vectorizes the resource data 425 and the task description 448 to generate a task embedding 452 defined in the same vector space as the task-owner embeddings 447. A comparator 456 then computes a similarity metric, such as a dot product or cosign similarity, between the task embedding 452 and each one of the task-owner embeddings 447 to identify one or more “similar previous tasks” documented in the ownership assignment database 421 that satisfy a similarity threshold with the task embedding 452 (e.g., a dot product in excess of a threshold). The similar previous tasks are shown in FIG. 3 as similar previous task information 449.

Notably, the similar previous task information 449 may, as a result of the above-described semantic retrieval operation, identify previous task that are similar in nature and/or that operate on similar resources, as well as the respective ownership of those tasks. This information can therefore be useful in identifying individuals within the enterprise with the skills and access credentials to perform the task that is presently being assigned.

The resource data 425 and the similar previous task information 449 are, together, along with the task description 448, provide as inputs to an attribute definer 442 that, in turn, generates the roll description 424 which describes qualification(s) of the potential task owner, as generally described with respect to any of FIG. 1-3.

In one implementation, the attribute definer 442 provides a generative language model 414 with inputs that include the resource data 425, the task description 448, the similar previous task information 449, and an instruction to use the resource data 425 and to generate a roll description that describes characteristics of a candidate capable of performing the task described in the task description 448. The generative language model 414 is, in this implementation, also provided with an instruction to use the relevent previous task information 449 to identify specific people within the enterprise that should be considered as candidates for the roll or eliminated from candidacy for the roll. The instruction further directs the generative language model 414 to include inferences relevant to the similar previous task information 449 in the roll description 424.

The roll description 424 further includes one or more past task inferences 459 that are derived from the similar previous task information 449. These past task inference 459 identify relevant qualifications (or lack thereof) of specific individuals that are inferred from previously assigned tasks of the workflow orchestration system 400. For instance, in the example shown, the roll description 424 identifies the fact that “UserK performed a similar task in 2022.”

Following generation of the roll description 424 as described above, the roll description 424 is provided to a candidate identifier (not shown) and used to identify candidates potentially qualified to own the task. This candidate identification and subsequent candidate selection (e.g., ownership assignment) select may be performed in a manner consistent with that described elsewhere herein.

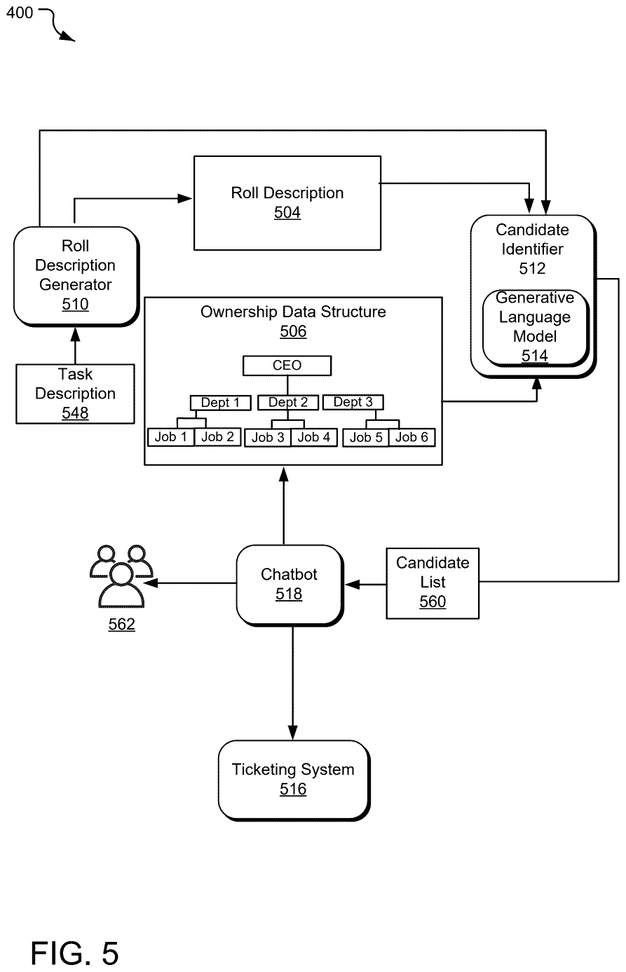

FIG. 5 aspects of another example workflow orchestration system that uses a generative language model 514 to identify a list of candidates 560 for performing a particular task in a response workflow. The workflow orchestration system 500 includes a roll description generator 510 that receives, as input, a task description 548 that identifies task by way of both an action and a target resource that is to be subject to the action. In response, the roll description generator 510 mines resource data from a security graph (not shown) that identifies relationship data and metadata for the target resource identified in the task description 548 and uses this information to generate a roll description 504, which may include the same or similar types of information to that described with respect to any of FIG. 1-4.

A candidate identifier 512 receives the task description 548, the roll description 504, and an ownership data structure 506 for the organization that includes at least employee names associated with position titles or descriptions. In FIG. 5, the candidate identifier 512 includes a generative language model 514. The candidate identifier 512 provides the generative language model 514 with an instruction to identify candidates named in the ownership data structure 506 that are likely to be best suited for the roll described in the roll description 404. For example, the generative language model 514 receives an instruction that reads “Here is a roll description, a task description, and an ownership data structure. The roll description identifies attributes of a candidate that is qualified to perform the task identified in the task description. Use the the roll description and information stored within the ownership data structure to name one or more individuals potentially qualified to perform the task.” In in response, the generative language model 514 makes semantic inferences that abridge qualifications in the roll description 504 with position title, job description, and/or other information tied to specific individuals in the ownership data structure 506. The generative language model 514 outputs a candidate list 560.

A chatbot 518 receives the candidate list 560, access contact information for each candidate (e.g., within the ownership data structure 506) and interview various candidate on the candidate list 560 to confirm suitability for the roll of task owner and/or to collect addition ownership information, as is generally described with respect to FIG. 1. As the chatbot 518 discovers new skill attributes and access attributes for specific individuals (e.g., via conversations with users 562), the chatbot 518 updates the ownership data structure 506 to store such information. Upon interviewing a select candidate from the candidate list 560 that provides an ownership confirmation for the task described in the task description 548, the chatbot 518 opens a new ticket in a ticketing system 516 that formally assigns the task to the candidate, which allows task progress to be tracked through to completion. Aspects of the workflow orchestration system 450 not explicitly described with respect to FIG. 4 may be the same or similar to components and functions described with respect to any of FIG. 1-3 described herein.

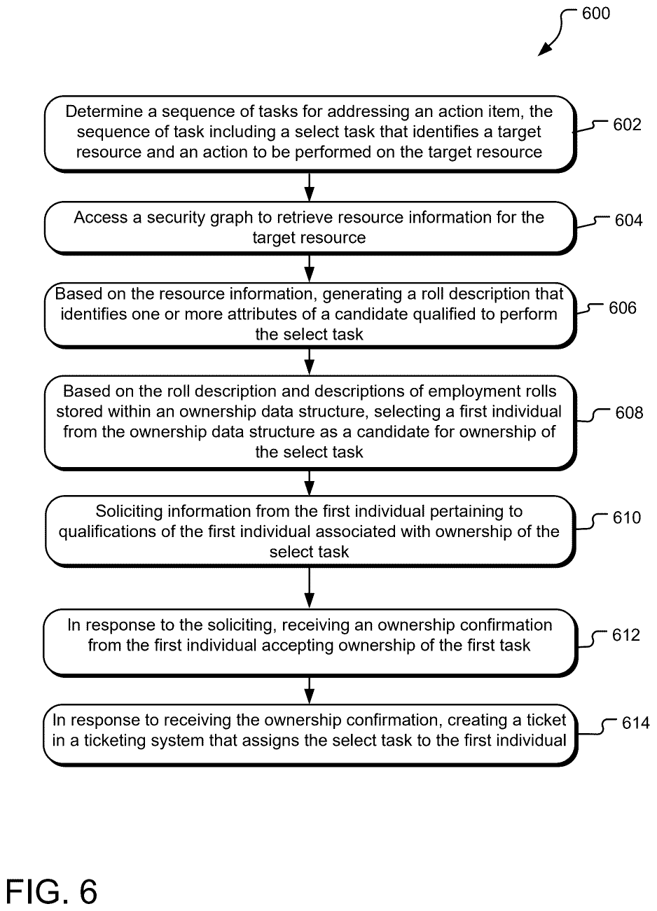

FIG. 6 illustrates example operations for autonomously learning an ownership data structure of an enterprise and using the ownership data structure to assign tasks in a workflow to corresponding owners. A determining operation 602 determines a sequence of tasks for addressing an action item. In one implementation, the action item is a response strategy for responding to a security exposure. The sequence of tasks may be initial defined in a variety of ways including by a system administrator or a retrieval augmented generation (RAG) system as described elsewhere herein. The sequence of tasks includes multiple tasks, including a select task that identifies target resource and an action to be performed on the target resource.

A graph access operation 604 accesses a security graph to retrieve resource information pertaining to the target resource of the select task in the sequence of tasks. In one implementation, the resource information retrieved from the security graph includes relationship data for the target resource that identifies an entity with access to the target resource and resource data that identifies a team, project, or employment roll associated with the target resource.

A roll description generation operation 606 generates a roll description that identifies one or more attributes of a candidate qualified to perform the select task. For example, the roll description identifies one or more access attributes descriptive of a person with access to the target resource and one or more skill attributes descriptive of a person that has a skill that is required or potentially helpful in performing the select task.

A candidate selection operation 608 selects a first individual from an ownership data structure as a candidate for ownership of the select task based on the roll description and descriptions of employment rolls stored within the ownership data structure. In one implementation, a generative language model selects the candidate in response to receiving the roll description, the ownership data structure, and an instruction to select one or more candidates from the ownership data structure that have corresponding employment rolls or other metadata that appears relevant to the attributes described within the roll description.

A soliciting operation 610 solicits information from the first individual pertaining to qualifications of the first individual associated with ownership of the select task. In one implementation, the soliciting information is performed by a chatbot that initiates an interview with the first individual to inquire about ownership of the select task. For example, the chatbot asks the first individual if they are qualified to perform the select task. An ownership confirmation operation 612 receives an ownership confirmation from the first individual (e.g., via the chatbot). The ownership confirmation accepts ownership of the select task.

In response to the ownership confirmation operation 612, a ticket creation operation 614 creates a ticket in a ticketing system that assigns the select task to the first individual.

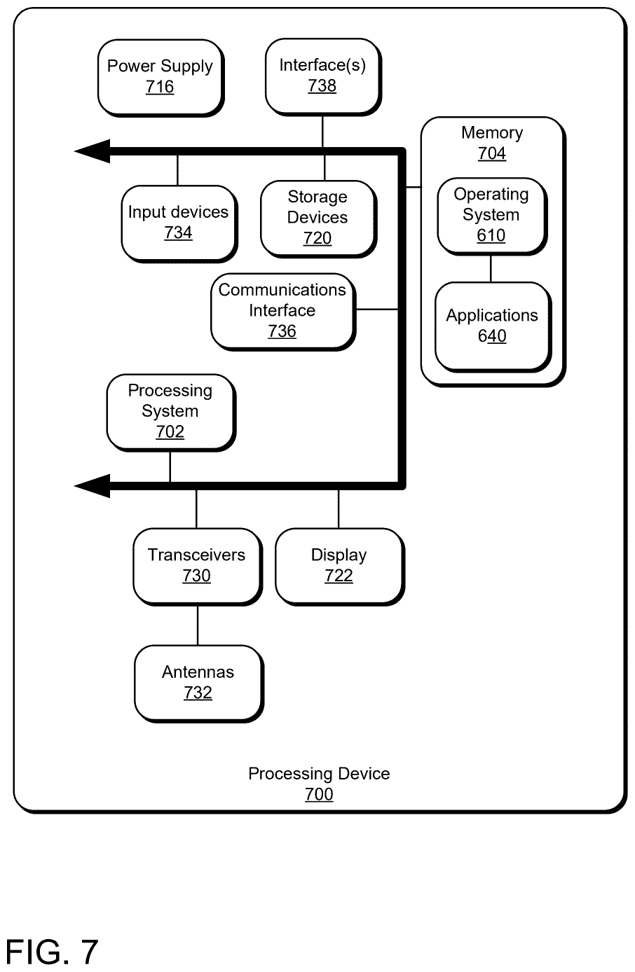

FIG. 7 illustrates an example computing device 700 for use in implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes a processing system 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 770, as shown in FIG. 7, one or more software modules, segments, and/or processors, such as applications 750 (e.g., the task assignment agent 102 or ticketing system 116 of FIG. 1) are loaded into the operating system 710 on the memory 704 and/or the storage 720 and executed by the processor(s) 672. The storage 620 may store an ownership data structure (e.g., the ownership data structure 106 of FIG. 1), a security graph (e.g., the security graph 122 of FIG. 1), as well as descriptions of security events and corresponding response strategies, chat histories, and ownership information and task information for previously assigned tasks.

The computing device 700 may include one or more communication transceivers 630, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a method including: determining a sequence of tasks for addressing an action item, the sequence of tasks including a select task that identifies a target resource and an action to be performed on the target resource; accessing a security graph to retrieve resource information pertaining to the target resource of a select task in the sequence of tasks, the resource information including relationship data for the target resource that identifies an entity with access to the target resource or resource data that identifies a team, project, or employment roll associated with the target resource; based on the resource information, generating a roll description that identifies one or more attributes of a candidate qualified to perform the select task; based on the roll description and descriptions of employment rolls stored within an ownership data structure, selecting a first individual from the ownership data structure as a candidate for ownership of the select task; soliciting information from the first individual pertaining to qualifications of the first individual associated with perform the select task; in response to the soliciting, receiving an ownership confirmation from the first individual accepting ownership of the select task; and in response to receiving the ownership confirmation, creating a ticket in a ticketing system that assigns the select task to the first individual.

In some aspects, the techniques described herein relate to a method, wherein soliciting information from the first individual further includes initiating, with a chatbot, an interview with the first individual to inquire about ownership of the select task, and wherein the chatbot receives the ownership confirmation from the first individual

In some aspects, the techniques described herein relate to a method, further including: in response to receiving the ownership confirmation from the first individual, updating a node corresponding to the first individual in the ownership data structure to include metadata describing the select task assigned to the first individual.

In some aspects, the techniques described herein relate to a method, wherein selecting the candidate to perform the select task includes providing a generative language model with inputs that include the roll description, the ownership data structure, and an instruction to select the candidate from the ownership data structure based on the roll description, and wherein the method further includes receiving outputs from the generative language model that identify the first individual as the candidate.

In some aspects, the techniques described herein relate to a method, further including: creating a task embedding that corresponds to the select task and that embeds a description of the select task and at least a portion of the resource information retrieved from the security graph; and accessing an index that stores chat history embeddings that embed chat history information acquired by the chatbot during interviews with candidates selected in association with tasks corresponding to previously created tickets in the ticketing system; executing a semantic retrieval operation to identify a subset of the chat history embeddings that satisfy similarity criteria with the task embedding, wherein the roll description further includes relevant chat history data corresponding to the subset of the chat history embeddings.

In some aspects, the techniques described herein relate to a method, further including: creating a task embedding that corresponds to the select task and that embeds a description of the select task and at least a portion of the resource information retrieved from the security graph; and accessing an index that stores task-owner embeddings that respective embed information describing previous tasks, resources acted upon by the previous tasks, and owners assigned to the previous tasks in the ticketing system; executing a semantic retrieval operation to identify a subset of the task-owner embeddings that satisfy similarity criteria with the task embedding, wherein the roll description further includes similar previous task information that is embedded within the task-owner embeddings, the similar previous task information identifying a previously performed task and an owner of the previously performed task in the ticketing system.

In some aspects, the techniques described herein relate to a method, wherein selecting the first individual as the candidate further includes selecting the first individual and a second individual from the ownership data structure as candidates for performing the select task, wherein the method further includes: initiating, with the chatbot, an interview with the second individual to inquire about ownership of the select task; and receiving, at the chatbot, a denial of the ownership from the second individual; in response to receiving the denial, initiating the interview with the first individual.

In some aspects, the techniques described herein relate to a method, wherein the action item is a response to an event and wherein determining the sequence of tasks further includes: providing the generative language model with inputs identifying the event, a generalized response strategy for responding to the event, and an instruction to identify a sequence of tasks executable to implement the generalized response strategy; receiving, from the generative language model, the sequence of tasks.

In some aspects, the techniques described herein relate to a system including: a task assignment agent stored in memory that: determines a sequence of tasks for addressing an action item, the sequence of tasks including a select task identifying a target resource and an action to be performed on the target resource; accesses a security graph to retrieve resource information pertaining to the target resource of a select task in the sequence of tasks; instructs a generative language model to utilize the resource information retrieved from the security graph to generate a roll description that identifies one or more attributes of a candidate qualified to perform the select task; receives from the generative language model the roll description; accesses an ownership data structure identifying individuals within an enterprise and descriptions of employment rolls served by the individuals; based on the roll description and the descriptions of employment rolls stored within the ownership data structure, selects a first individual from the ownership data structure as a candidate for ownership of the select task; initiates, with a chatbot, an interview with the first individual to inquire about ownership of the select task; receives at the chatbot, an ownership confirmation from the first individual accepting ownership of the select task; and in response to receiving the ownership confirmation, creates a ticket in a ticketing system that assigns the select task to the first individual.

In some aspects, the techniques described herein relate to a system, wherein the resource information includes relationship data for the target resource that identifies an entity with access to the target resource or resource metadata that identifies a team, project, or employment roll associated with the target resource.

In some aspects, the techniques described herein relate to a system, wherein selecting the first individual as the candidate includes providing the generative language model with inputs that include the roll description, the ownership data structure, and an instruction to select the candidate from the ownership data structure based on the roll description.

In some aspects, the techniques described herein relate to a system, wherein the task assignment agent is further configured to: create a task embedding that corresponds to the select task and that embeds a description of the select task and at least a portion of the resource information retrieved from the security graph; and accesses an index storing chat history embeddings that embed chat history information acquired by the chatbot during interviews with candidates selected in association with tasks corresponding to previously created tickets in the ticketing system; executes a semantic retrieval operation to identify a subset of the chat history embeddings that satisfy similarity criteria with the task embedding, wherein the roll description further includes relevant chat history data corresponding to the subset of the chat history embeddings.

In some aspects, the techniques described herein relate to a system, wherein the task assignment agent is further configured to: create a task embedding that corresponds to the select task and that embeds a description of the select task and at least a portion of the resource information retrieved from the security graph; and accesses an index that stores task-owner embeddings that embed information identifying previously assigned tasks and corresponding ownership information; executing a semantic retrieval operation to identify a subset of the task-owner embeddings that satisfy similarity criteria with the task embedding, wherein the roll description further includes similar previous task information that is embedded within the task-owner embeddings.

In some aspects, the techniques described herein relate to a system, wherein the task assignment agent is further configured to: select the first individual and a second individual from the ownership data structure as candidates for performing the select task; initiate an interview with the second individual to inquire about ownership of the select task; and receive a denial of the ownership from the second individual; in response to receiving the denial, initiate the interview with the first individual.

In some aspects, the techniques described herein relate to a system, wherein the action item is a response to an event and wherein the task assignment agent determines the sequence of tasks, in part, by: providing the generative language model with inputs identifying the event, a generalized response strategy for responding to the event, and an instruction to identify a sequence of tasks executable to implement the generalized response strategy; and receiving, from the generative language model, the sequence of tasks.

In some aspects, the techniques described herein relate to a system, wherein the task assignment agent provides at least a portion of the inputs to a Retrieval Augmentation Generation (RAG) system that performs a semantic retrieval operation to retrieve context data relevant to the event or the generalized response strategy, wherein providing the generative language model with the inputs further includes providing the generative language model with the context data.

In some aspects, the techniques described herein relate to one or more tangible processor-readable storage media encoding instructions for executing a computer process, the computer process including: utilizing a retrieval augmented generation (RAG system) to determine a sequence of tasks executable to implement a response strategy, the sequence of tasks include a select task identifying a target resource and an action to be performed on the target resource; mining, from a security graph, resource information pertaining to the target resource of a select task in the sequence of tasks, the resource information including relationship data for the target resource that identifies an entity with access to the target resource or resource metadata that identifies a team, project, or employment roll associated with the target resource; accessing an ownership data structure identifying employees of an enterprise and descriptions of employment rolls served by the employees; instruct a generative language model to utilize the resource information mined from the security graph to identify a candidate from the ownership data structure qualified to perform the select task; receiving an ownership confirmation from the candidate accepting ownership of the select task; and in response to receiving the ownership confirmation, creating a ticket in a ticketing system that assigns the select task to the candidate.

In some aspects, the techniques described herein relate to one or more tangible processor-readable storage media, wherein the computer process further includes: in response to receiving the ownership confirmation from the candidate, updating a node corresponding to the candidate in the ownership data structure to include metadata describing the select task assigned to the candidate.

In some aspects, the techniques described herein relate to one or more tangible processor-readable storage media, wherein the computer process further includes: creating a task embedding that corresponds to the select task and that embeds a description of the select task and at least a portion of the resource information retrieved from the security graph; and accessing an index that stores chat history embeddings that embed chat history information acquired by a chatbot during interviews with candidates selected in association with tasks corresponding to previously created tickets in the ticketing system; executing a semantic retrieval operation to identify a subset of the chat history embeddings that satisfy similarity criteria with the task embedding, wherein instructing the generative language model to identify a candidate further includes providing the generative language model with relevant chat history data corresponding to the subset of the chat history embeddings.

In some aspects, the techniques described herein relate to one or more tangible processor-readable storage media, wherein the computer process further includes: creating a task embedding that corresponds to the select task and that embeds a description of the select task and at least a portion of the resource information retrieved from the security graph; and accessing an index that stores task-owner embeddings pertaining to previously assigned tasks, the task-owner embeddings describing the previously assigned tasks and identifying owners assigned to the previously assigned tasks in the ticketing system; executing a semantic retrieval operation to identify a subset of the task-owner embeddings pertaining to the previously assigned tasks that satisfy similarity criteria with the task embedding, wherein instructing the generative language model to identify a candidate further includes providing the generative language model with information embedded within the subset of the task-owner embeddings pertaining to the previously assigned tasks. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method comprising:
determining a sequence of tasks for addressing an action item, the sequence of tasks including a select task that identifies a target resource and an action to be performed on the target resource;
accessing a security graph to retrieve resource information pertaining to the target resource of a select task in the sequence of tasks, the resource information including relationship data for the target resource that identifies an entity with access to the target resource or resource data that identifies a team, project, or employment roll associated with the target resource;
based on the resource information, generating a roll description that identifies one or more attributes of a candidate qualified to perform the select task;
based on the roll description and descriptions of employment rolls stored within an ownership data structure, selecting a first individual from the ownership data structure as a candidate for ownership of the select task;
soliciting information from the first individual pertaining to qualifications of the first individual associated with perform the select task;
in response to the soliciting, receiving an ownership confirmation from the first individual accepting ownership of the select task; and
in response to receiving the ownership confirmation, creating a ticket in a ticketing system that assigns the select task to the first individual.

2. The method of claim 1, wherein soliciting information from the first individual further comprises initiating, with a chatbot, an interview with the first individual to inquire about ownership of the select task, and wherein the chatbot receives the ownership confirmation from the first individual.

3. The method of claim 1, further comprising:
in response to receiving the ownership confirmation from the first individual, updating a node corresponding to the first individual in the ownership data structure to include metadata describing the select task assigned to the first individual.

4. The method of claim 1, wherein selecting the candidate to perform the select task includes providing a generative language model with inputs that include the roll description, the ownership data structure, and an instruction to select the candidate from the ownership data structure based on the roll description, and wherein the method further includes receiving outputs from the generative language model that identify the first individual as the candidate.

5. The method of claim 2, further comprising:
creating a task embedding that corresponds to the select task and that embeds a description of the select task and at least a portion of the resource information retrieved from the security graph; and
accessing an index that stores chat history embeddings that embed chat history information acquired by the chatbot during interviews with candidates selected in association with tasks corresponding to previously created tickets in the ticketing system;
executing a semantic retrieval operation to identify a subset of the chat history embeddings that satisfy similarity criteria with the task embedding, wherein the roll description further includes relevant chat history data corresponding to the subset of the chat history embeddings.

6. The method of claim 3, further comprising:
creating a task embedding that corresponds to the select task and that embeds a description of the select task and at least a portion of the resource information retrieved from the security graph; and
accessing an index that stores task-owner embeddings that respective embed information describing previous tasks, resources acted upon by the previous tasks, and owners assigned to the previous tasks in the ticketing system;
executing a semantic retrieval operation to identify a subset of the task-owner embeddings that satisfy similarity criteria with the task embedding, wherein the roll description further includes similar previous task information that is embedded within the task-owner embeddings, the similar previous task information identifying a previously performed task and an owner of the previously performed task in the ticketing system.

7. The method of claim 2, wherein selecting the first individual as the candidate further comprises selecting the first individual and a second individual from the ownership data structure as candidates for performing the select task, wherein the method further comprises:
initiating, with the chatbot, an interview with the second individual to inquire about ownership of the select task; and
receiving, at the chatbot, a denial of the ownership from the second individual;
in response to receiving the denial, initiating the interview with the first individual.

8. The method of claim 4, wherein the action item is a response to an event and wherein determining the sequence of tasks further comprises:
providing the generative language model with inputs identifying the event, a generalized response strategy for responding to the event, and an instruction to identify a sequence of tasks executable to implement the generalized response strategy;
receiving, from the generative language model, the sequence of tasks.

9. A system comprising:
a task assignment agent stored in memory that:
determines a sequence of tasks for addressing an action item, the sequence of tasks including a select task identifying a target resource and an action to be performed on the target resource;
accesses a security graph to retrieve resource information pertaining to the target resource of a select task in the sequence of tasks;
instructs a generative language model to utilize the resource information retrieved from the security graph to generate a roll description that identifies one or more attributes of a candidate qualified to perform the select task;
receives from the generative language model the roll description;
accesses an ownership data structure identifying individuals within an enterprise and descriptions of employment rolls served by the individuals;
based on the roll description and the descriptions of employment rolls stored within the ownership data structure, selects a first individual from the ownership data structure as a candidate for ownership of the select task;
initiates, with a chatbot, an interview with the first individual to inquire about ownership of the select task;
receives at the chatbot, an ownership confirmation from the first individual accepting ownership of the select task; and
in response to receiving the ownership confirmation, creates a ticket in a ticketing system that assigns the select task to the first individual.

10. The system of claim 9, wherein the resource information includes relationship data for the target resource that identifies an entity with access to the target resource or resource metadata that identifies a team, project, or employment roll associated with the target resource.

11. The system of claim 9, wherein selecting the first individual as the candidate includes providing the generative language model with inputs that include the roll description, the ownership data structure, and an instruction to select the candidate from the ownership data structure based on the roll description.

12. The system of claim 9, wherein the task assignment agent is further configured to:
create a task embedding that corresponds to the select task and that embeds a description of the select task and at least a portion of the resource information retrieved from the security graph; and
accesses an index storing chat history embeddings that embed chat history information acquired by the chatbot during interviews with candidates selected in association with tasks corresponding to previously created tickets in the ticketing system;
executes a semantic retrieval operation to identify a subset of the chat history embeddings that satisfy similarity criteria with the task embedding, wherein the roll description further includes relevant chat history data corresponding to the subset of the chat history embeddings.

13. The system of claim 9, wherein the task assignment agent is further configured to:
create a task embedding that corresponds to the select task and that embeds a description of the select task and at least a portion of the resource information retrieved from the security graph; and
accesses an index that stores task-owner embeddings that embed information identifying previously assigned tasks and corresponding ownership information;
executing a semantic retrieval operation to identify a subset of the task-owner embeddings that satisfy similarity criteria with the task embedding, wherein the roll description further includes similar previous task information that is embedded within the task-owner embeddings.

14. The system of claim 9, wherein the task assignment agent is further configured to:
select the first individual and a second individual from the ownership data structure as candidates for performing the select task;
initiate an interview with the second individual to inquire about ownership of the select task; and
receive a denial of the ownership from the second individual;
in response to receiving the denial, initiate the interview with the first individual.

15. The system of claim 9, wherein the action item is a response to an event and wherein the task assignment agent determines the sequence of tasks, in part, by:
providing the generative language model with inputs identifying the event, a generalized response strategy for responding to the event, and an instruction to identify a sequence of tasks executable to implement the generalized response strategy; and
receiving, from the generative language model, the sequence of tasks.

16. The system of claim 15, wherein the task assignment agent provides at least a portion of the inputs to a Retrieval Augmentation Generation (RAG) system that performs a semantic retrieval operation to retrieve context data relevant to the event or the generalized response strategy, wherein providing the generative language model with the inputs further comprises providing the generative language model with the context data.

17. One or more tangible processor-readable storage media encoding instructions for executing a computer process, the computer process comprising:
utilizing a retrieval augmented generation (RAG system) to determine a sequence of tasks executable to implement a response strategy, the sequence of tasks include a select task identifying a target resource and an action to be performed on the target resource;
mining, from a security graph, resource information pertaining to the target resource of a select task in the sequence of tasks, the resource information including relationship data for the target resource that identifies an entity with access to the target resource or resource metadata that identifies a team, project, or employment roll associated with the target resource;
accessing an ownership data structure identifying employees of an enterprise and descriptions of employment rolls served by the employees;
instruct a generative language model to utilize the resource information mined from the security graph to identify a candidate from the ownership data structure qualified to perform the select task;
receiving an ownership confirmation from the candidate accepting ownership of the select task; and
in response to receiving the ownership confirmation, creating a ticket in a ticketing system that assigns the select task to the candidate.

18. The one or more tangible processor-readable storage media of claim 17, wherein the computer process further comprises:
in response to receiving the ownership confirmation from the candidate, updating a node corresponding to the candidate in the ownership data structure to include metadata describing the select task assigned to the candidate.

19. The one or more tangible processor-readable storage media of claim 17, wherein
the computer process further comprises:
creating a task embedding that corresponds to the select task and that embeds a description of the select task and at least a portion of the resource information retrieved from the security graph; and
accessing an index that stores chat history embeddings that embed chat history information acquired by a chatbot during interviews with candidates selected in association with tasks corresponding to previously created tickets in the ticketing system;
executing a semantic retrieval operation to identify a subset of the chat history embeddings that satisfy similarity criteria with the task embedding, wherein instructing the generative language model to identify a candidate further comprises providing the generative language model with relevant chat history data corresponding to the subset of the chat history embeddings.

20. The one or more tangible processor-readable storage media of claim 17, wherein the computer process further comprises:
creating a task embedding that corresponds to the select task and that embeds a description of the select task and at least a portion of the resource information retrieved from the security graph; and
accessing an index that stores task-owner embeddings pertaining to previously assigned tasks, the task-owner embeddings describing the previously assigned tasks and identifying owners assigned to the previously assigned tasks in the ticketing system;
executing a semantic retrieval operation to identify a subset of the task-owner embeddings pertaining to the previously assigned tasks that satisfy similarity criteria with the task embedding, wherein instructing the generative language model to identify a candidate further comprises providing the generative language model with information embedded within the subset of the task-owner embeddings pertaining to the previously assigned tasks.
